(19) United States
(12) Patent Application Publication
(10) Pub. No.: US 2011/0101744 A1
(43) Pub. Date: May 5, 2011

(54) VEHICULAR SEATING SYSTEM

(75) Inventors: Padraig J. Naughton, Terneuzen (NL); Prashant Shembekar, Maharashtra (IN)

(73) Assignee: Dow Global Technologies Inc.

(21) Appl. No.: 12/992,614

(22) PCT Filed: Jul. 14, 2008
(86) PCT No.: PCT/US08/69955

§ 371 Date: Jan. 25, 2011

(30) Foreign Application Priority Data
May 23, 2008 (IN) 1263/CHE/2008

(51) Int. Cl. B60N 2/48; B60N 2/58; B60N 2/44; B29C 67/20

(52) U.S. Cl. 297/216.1; 264/46.6

(57) ABSTRACT

The improved seating assembly for an automotive vehicle, includes a molded plastic seat (22) with a plurality of integrated reinforcement structures (30) disposed therein. A foam support structure with a top foam surface, a side foam surface, and a bottom foam surface, wherein the bottom foam surface may be disposed upon the molded plastic seat. A cover skin disposed on the top foam surface and the side foam surface.

### CLAIM OF BENEFIT OF FILING DATE

The present application claims the benefit of the filing date of Indian Application Serial No. 1263/CHE/2008, filed 23 May 2008 which is hereby incorporated by reference for all purposes.

### FIELD OF THE INVENTION

The present invention relates to an improved seating system, and more particularly to an improved system for automotive vehicle seating.

### BACKGROUND

Efforts to improve vehicle seats have received increased attention in recent years in view of more rigid governmental standards for cargo retention. The ability to address this need with a cost effective and generally lightweight material selection has resulted in a number of seating system developments as exemplified in U.S. Pat. Nos. 6,491,346; 6,688,700; 6,739,673; 6,997,515, 7,128,373 and 7,137,670; hereby incorporated by reference for all purposes. Notwithstanding these advancements, there remains a desire to present alternative solutions for various applications, in particular for cases where seat cushions and backs are integrated into a single part.

### SUMMARY OF THE INVENTION

The present invention is directed to one such solution, and particularly is directed to a molded plastic seat having at least a first wall portion with a forward and rearward surface, an optional opposing second wall portion, a foam bun and seat cover (optionally molded in-situ with the plastic seat), all configured to create an integral cushion, back portion and optional head restraint portion. One potential advantage of the present invention is the ability to employ plastics heretofore regarded as less practical for complete seat applications that require more stringent loading requirements, such as polyolefin and polyethylene. Additionally, the invention affords the ability to selectively improve local properties, reduce wall thickness and section thickness, reduce the total number of parts needed to construct the seat assembly, reduce the potential squeak and rattles (e.g. fewer parts, no relative movement), and reduce corrosion (plastic does not rust).

Advantageously, the seating system upon rapid acceleration up to about 20 to about 30 g or even up to 50 g, there may be no fragmentation of the seat back with at least a 15 kg mass placed behind the seat. Advantageously, the seating system also may withstand a force producing a moment of about 530 Nm in relation to the seating reference point (R) applied longitudinally and rearwards to the upper part of the seat back portion through a component simulating the back of a manikin, and the optional head restraint portion of the seat may be capable of limiting acceleration of spherical headform, weighing at least about 6.8 Kg, striking at a speed of at least about 24.1 Km/h to less than 80 g for more than continuous 3 ms during an impact event. “Seating Reference Point” (R) is the manufacturer's design reference point that establishes the rearmost riding position on the seat and simulates the position of the pivot centre of the human torso and thigh. The system can be easy to manufacture and will not add substantial weight to the vehicle as compared with other commercial seating systems.

Accordingly, pursuant to one aspect of the present invention, there is contemplated a molded plastic seat that may have at least a first wall portion including a forward wall portion and a rearward wall portion, a plurality of integrated reinforcement structures disposed on the forward wall portion, the rearward wall portion, or both, further may include a cushion portion statically connected to a back portion and optionally a head restraint portion, the cushion portion may include a top cushion wall portion and a bottom cushion wall portion, wherein the bottom cushion wall portion can be adapted to connectively interface with the vehicle; a foam support structure with a top foam surface, a side foam surface, and a bottom foam surface, wherein the bottom foam surface may be disposed upon the forward wall portion of the molded plastic seat; and a cover skin disposed on the top foam surface and the side foam surface; wherein the seat assembly can be capable of withstanding, without rupture, at least about 5000 Newtons in a direction in which the seat faces in a plane, parallel to the longitudinal centerline of the vehicle, and exhibits, upon rapid acceleration up to about 20 to about 30 g, no fragmentation of the seating assembly with at least a 15 kg mass placed behind the seating assembly.

The invention may be further characterized by one or any combination of the features described herein, such as the cushion portion, the back portion, the head restraint portion and the plurality of integrated reinforcement structures may include a single unitary molded plastic component; a second wall portion including a second forward wall portion and a second rearward wall portion. The molded plastic seat may be molded from a thermoplastic resin. The thermoplastic resin may include a fiber filled polyolefin. The molded plastic seat can be fabricated by single injection molding, blow molding, compression molding, vacuum molding, or any combination thereof. The foam support structure can be fabricated and joined with the molded plastic seat and the cover skin in a single foaming operation. The molded plastic includes an attachment feature for the optional head restraint portion.

Accordingly, pursuant to another aspect of the present invention, there is contemplated a method of manufacturing a seating assembly for an automotive vehicle that may include the steps of forming a thermoplastic seat with a cushion portion integrally connected to a back portion and a head restraint portion; providing a cover skin; placing the thermoplastic seat securely onto a lid portion of a foam mold; placing the cover skin securely into a bowl portion of the foam mold; introducing an expandable foam into the foam mold; and expanding the expandable foam to fill the mold, thus joining the cover skin and the thermoplastic seat to the expanded foam creating the seating assembly.

The invention may be further characterized by one or any combination of the features described herein, such as the cover skin may be secured to the bowl by a step of applying a vacuum between the bowl and the cover skin. A step of closing the lid portion onto the bowl portion may occur after the expandable foam is introduced to the foam mold.

### DESCRIPTION OF THE DRAWINGS

FIG. 1 is perspective view of one exemplary seat according to the teachings of the present invention.

FIG. 2 is perspective view of one exemplary seat structure according to the teachings of the present invention.

FIG. 2A is a cross-sectional view through the one exemplary seat structure shown in FIG. 2.

FIG. 3 is a cross-sectional view without the seat structure shown through the one exemplary seat structure shown in FIG. 1.

FIG. 4 is perspective view of a second exemplary seat according to the teachings of the present invention.

FIG. 4A is a cross-sectional view with the seat structure shown through the one exemplary seat structure shown in FIG. 4.

FIG. 5 is perspective view of one exemplary seat structure with a head form according to the teachings of the present invention.

### DETAILED DESCRIPTION OF THE PREFERRED EMBODIMENT

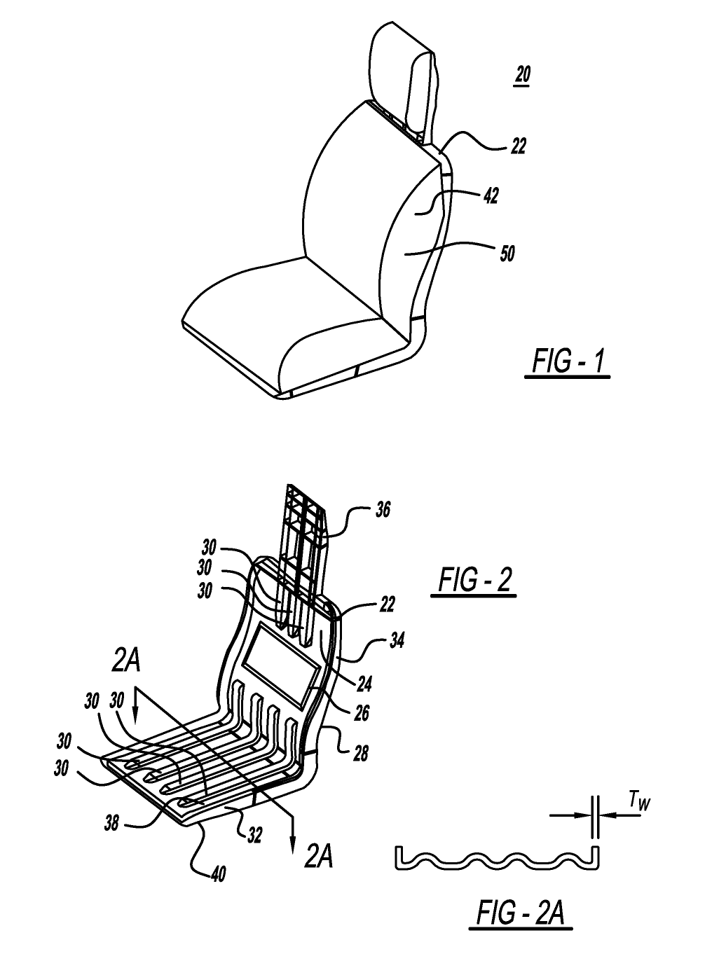

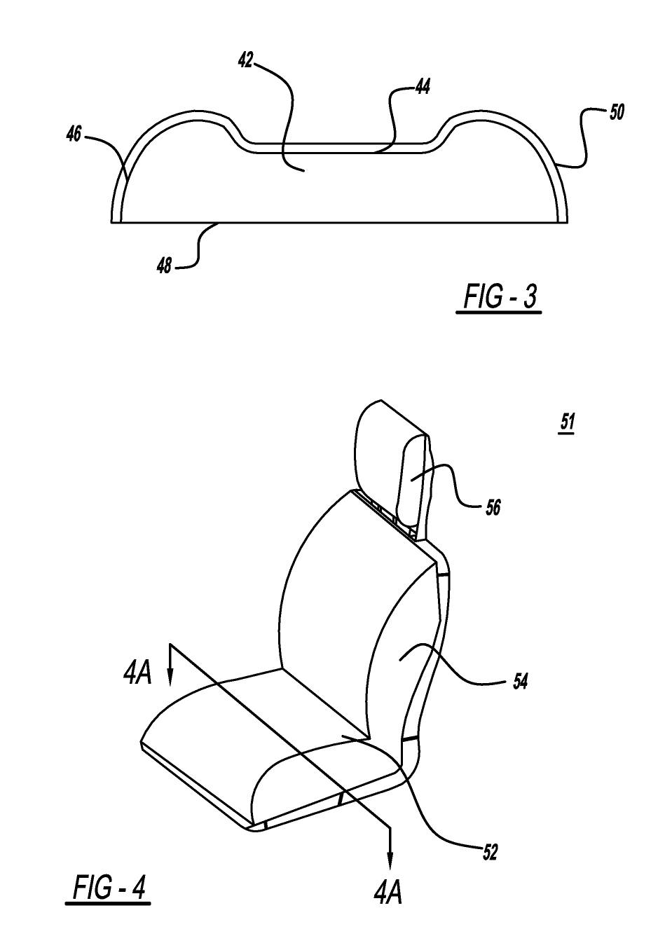

Referring to FIGS. 1-3, the present invention is premised upon the development of an improved automotive vehicle seat assembly 20. The improved automotive vehicle seat assembly 20 having primarily a plastic structure or molded plastic seat 22, although some additional non-integral reinforcements (e.g. metallic, fabric, fibrous composite, and/or optionally at least one directional reinforcement under pre-tension), not shown, may be employed. Typically, these reinforcements may be located in the seat/vehicle interface and in locally high stress or fatigue prone areas. The improved automotive vehicle seat assembly 20 may also include a foam support structure 42 (e.g. a polyurethane foam bun) and a cover skin 50.

Generally, the invention contemplates a molded plastic seat 22 that may include at least a first wall portion 24 (e.g. a plastic part with a single wall thickness). The first wall portion may be defined as having a forward wall portion 26 and a rearward wall portion 28 with a thickness of T. The wall thickness T_{w} preferably is less than about 10.0 mm, more preferably less than about 7.0 mm and even more preferably less than 5.5 mm. The wall thickness T_{w} is also preferably at least 0.5 mm, and more preferably at least 1.5 mm. The molded plastic seat 22 could optionally have multiple wall portions, not shown, (e.g. two opposing walls as in a blow molded configuration or a joined multi-piece assembly). The molded plastic seat 22 also may contain a plurality of integrated reinforcement structures 30; these structures can be located on the forward wall portion 26, the rearward wall portion 28, or both. As will be appreciated, proper material selection will help permit efficient design and molding of optimal wall thicknesses in combination with proper selection integrated reinforcement structures size and location for achieving the desired performance without substantially increasing vehicle weight, costs or intruding into interior space availability. It should also be appreciated that the size, location and dimensions of the integrated reinforcement structures 30 can vary based upon such exemplary factors as overall seat package size, seat loading and fatigue requirements, and material selection.

The seat structure further may include a cushion portion 32 that may be statically connected (e.g. a continuous connection without any hinging mechanisms) to a back portion 34 and optionally to a head restraint portion 36. The cushion portion 32 may include a top cushion wall portion 38 and a bottom cushion wall portion 40. Additionally, the bottom cushion wall portion 40 may be adapted to connectively interface with the vehicle (e.g. connect via a seat track assembly or mounting platform which may be connected to the body in white). It is contemplated that the connection to the vehicle could be made by using mechanical fasteners (e.g. nuts, bolts, rivets or the like) or by an adhesive (e.g. adhesively bonding the cushion to a plate or bracket), or any combination thereof. Body in white or BIW refers to the car body sheet metal (typically including doors, hoods, and deck lids) but generally does not include power train components (e.g. transmission or motor) and trim (e.g. windshields, seats, upholstery, electronics, etc.) and is a well know term of art in the automotive industry.

The invention also may include a foam support structure 42 with a top foam surface 44 a side foam surface 46 and a bottom foam surface 48. The bottom foam surface 48 may be disposed upon the forward wall portion 26 of the molded plastic seat 22. It is contemplated that the foam support structure 42 may be connected to the molded plastic seat 22 via mechanical interlock, adhesive bonding or the like. This foam support structure 42 may be made of expandable polyurethane foam of the type typically used in automotive seating. An illustrative example of such foam may be found in U.S. Pat. No. 5,079,276 hereby incorporated by reference for all purposes. Wherein is described a method of manufacturing polyurethane foams comprising the steps of mixing a polyol and an organic isocyanate without causing them to substantially react with each other thereby to obtain a nonreacted mixture; mixing the nonreacted mixture with a foaming agent, a catalyst, a foam stabilizer and other necessary additives (e.g. pigment, fire retardant, and/or a filler); and injecting the resultant mixture to a mold to cause the resultant mixture to foam and crosslink.

The invention also may include a cover skin 50 disposed on the top foam surface 44 and the side foam surface 46. This cover may be integral to the foam support structure (e.g. self skinning foam) or may be a separate piece or pieces (e.g. a sewn trim cover or a prefabricated vinyl or urethane cover). In the case of separate piece or pieces, the cover skin 50 may be secured to the seat or the foam by a number of methods. Such securing methods may include the use of traditional seat trim mechanical fasteners (e.g. j-hooks, hog rings, hook and loop, or the like), by adhesive or vibration bonding, or preferably by in-situ molding.

Additionally, the invention contemplates that the seat assembly 20 may be capable of withstanding, without rupture, at least about 5000 Newtons in a direction in which the seat faces in a plane, parallel to the longitudinal centerline of the vehicle. Also, the seat assembly 20 may exhibit, upon rapid acceleration up to about 20 to about 30 g, no fragmentation of the seating assembly 20 with at least about a 15 kg mass placed behind the seating assembly 20. Furthermore, the seating assembly 20 may also withstand a force producing a moment of about 530 Nm in relation to the seating reference point (R) applied longitudinally and rearwards to the upper part of the seat back portion 34 through a component simulating the back of a manikin. The optional head restraint portion 36 of the seat may be capable of minimizing acceleration of a spherical headform 64 (shown in FIG. 5) weighing at least about 6.8 Kg to less than 80 g striking at a speed of at least about 24.1 Km/h for not more than continuous 3 ms.

In a first embodiment, as seen in FIGS. 1-3, it is contemplated that the molded plastic seat 22, which may include the cushion portion 32, the back portion 34, the head restraint portion 36 and the plurality of integrated reinforcement structures 30 may be fabricated as a single unitary molded plastic component. The fabrication of such a unitary molded component can occur using a variety of manufacturing methods, such as but not limited to: injection molding, reaction injection molding (RIM), compression molding, or vacuum forming. It is contemplated that the molded plastic seat 22 can be constructed of any number of filled (e.g. glass, talc, mineral, nano-composites, or the like) or unfilled plastic resins, such as but not limited to: polyethylene, polypropylene, polyester, nylon, styrenics, olefins, or any blend thereof. In the most preferred embodiment, the resin utilized may be a glass filled polypropylene that imparts the desirous material properties of high strength and high stiffness.

In this embodiment the foam support structure 42 may be integrally connected to the molded plastic seat 22 such that substantially all the bottom foam surface 48 mates with the forward wall portion 26 of the molded plastic seat 22. It is contemplated in this embodiment that both the molded plastic seat 22 and the cover skin 50 can be placed within the foam mold and the foam support structure may be formed in-situ between them.

The materials selected for forming the walls of the molded plastic seat 22 or 51 of the present invention preferably may exhibit an elastic modulus generally less than about 10000 MPa, more preferably less than about 7000 MPa, and even more preferably less than about 5000 MPa. Additionally, the materials selected for forming the walls may preferably exhibit an elastic modulus of at least about 500 MPa, more preferably of at least about 1000 MPa, and most preferably at least about 1500 MPa.

The flexural modulus of the molded plastic seat walls may be preferably less than about 6500 MPa, more preferably less than about 6000 MPa, and most preferably less than about 5500 MPa. The flexural modulus of the molded plastic seat walls may be preferably at least about 600 MPa, more preferably at least about 1300 MPa, and most preferably at least about 1700 MPa.

The preferred yield strength of the molded plastic seat walls may be preferably less than about 200 MPa, more preferably less than about 130 MPa, and most preferably less than about 70 MPa. The yield strength of the molded plastic seat walls may be preferably at least about 10 MPa, more preferably at least about 25 MPa, and most preferably at least about 35 MPa. Moreover, the ductility (as measured by percent elongation) of the material preferably may be preferably less than about 250%, more preferably less than about 180%, and most preferably less than about 150%. Additionally, the ductility may be at least about 1%, more preferably at least about 3%, and most preferably at least 10%.

The material also should preferably exhibit attractive processing characteristics, such as a melt flow rate (230 C/3.8 kg-l; according to ASTM D1238) of about 0.30 to about 15.0 g/10 min, more preferably from about 0.90 to about 9.0 g/10 min; a softening point (according to ASTM D1525) of less than about 200 C, and more preferably ranging from about 90 C to about 150 C; a linear-flow mold shrink (according to ASTM D 955) of about 0.001/mm/mm to about 0.2/mm/mm and more preferably about 0.003/mm/mm to about 0.09/mm/mm; or a combination of these properties.

Examples of preferred commercially available materials include Dow C702-20 Polypropylene and Magnum™ 1150EM, both available from The Dow Chemical Company and exemplar of the above mechanical properties. Further example is 40% long-glass filled polypropylene.

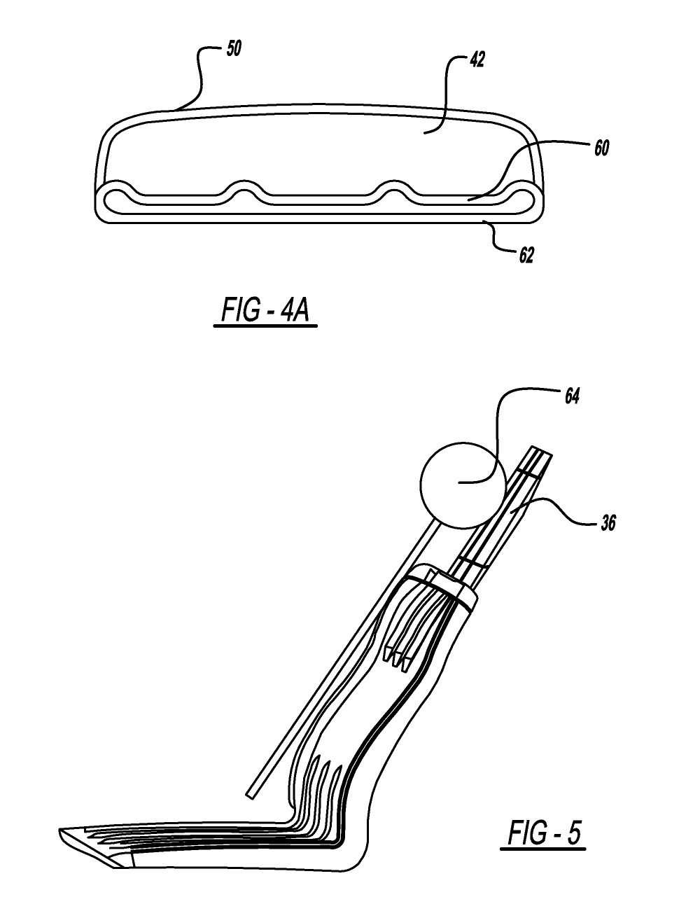

In a second embodiment, as seen in FIGS. 4-4A, it is contemplated that a second illustrative molded plastic seat 51, which may include the cushion portion 52, the back portion 54, the head restraint portion 56 and the plurality of integrated reinforcement structures 58. This may be fabricated as a unitary plastic assembly with at least two opposing walls, as illustrated as a first wall section 60 and a second wall section 62. This can be accomplished by a variety of manufacturing methods, such as but not limited to: blow molding, injection molding, compression molding or vacuum forming. It is contemplated that the first wall section 60 and the opposing second wall section 62 may be formed from the same material in a single operation (e.g. blow molding). It is also contemplated that the wall sections (60, 62) may be constructed from the same or different materials, formed in two separate operations, and then joined by a bonding process (e.g. adhesively bonded, vibration welded, or the like). It is contemplated that the material selection criteria, connections to the foam support structure 42, and connections the cover skin 50 are similar to the first embodiment and for the sake of brevity is not repeated.

In a third preferred embodiment, the molded plastic seat of the present invention may be made from a plastic material and processing method that is described in WO/2006/047366, herein incorporated by reference. Wherein the material described is premised upon the recognition for use as multiple layer elongated member of a propylene-based (e.g., a propylene-ethylene copolymer, a propylene-α-olefin copolymer, mixtures thereof or otherwise) copolymer that has a melting point that is below an adjoining polypropylene layer, and specifically an oriented polypropylene layer. Upon processing to form articles, the resulting materials (especially the oriented polypropylene layer) exhibits a degree of retained morphology from its initial drawn state heretofore not attainable using conventional materials. Accordingly, aspects of the material are premised upon the use of a propylene-ethylene copolymer that has an ethylene content of about 3 to about 25 wt. % (e.g., 5 to 15 wt. %), a melting range of about 50 to about 135° C., and a flexural modulus of about 8 to about 325 MPa or higher (e.g., at least about 375 MPa), and a second thermoplastic material that includes a polyolefin, such as a propylene-based polymer. Such propylene-ethylene copolymer may have a Shore A Hardness of from about 40 to 90 (or higher), a molecular weight distribution of about 1.5 to about 4, and a melt flow rate of at least about 0.3 g/10 min, or any combination thereof. Again, it is contemplated that the connections to the foam support structure 42 and connections the cover skin 50 are similar to the first embodiment and for the sake of brevity is not repeated.

In another aspect of the present invention, a method of manufacturing a seating assembly for an automotive vehicle is contemplated that may include the following steps. First, forming a thermoplastic seat with a cushion portion integrally connected to a back portion and optionally to a head restraint portion. Second, providing a cover skin (e.g. as a separate part to the total assembly or as an integral part of the foam). Third, placing the thermoplastic seat securely onto a lid portion of a foam mold. Fourth, placing the cover skin securely (e.g. being held down by gravity, a clipping system, by a vacuum, or any combination thereof) into a bowl portion of the foam mold. Fifth, introducing expandable foam into the foam mold (either before or after closing the mold). And finally, expanding the expandable foam to fill the mold, thus joining the cover skin and the thermoplastic seat to the expanded foam creating the seating assembly.

In yet another aspect of the present invention, it is contemplated that other components or systems may be integrated into the seat assembly. Items such as map pockets, air ducts, air vents, grab handles, umbrella holders, package clips, coin holders, or the like can be molded into the seat structure or attached via attachment features.

It will be appreciated that the above design criteria are preferred but are not intended as limiting. Depending upon the particular applications, variations to the above may be made.

The skilled artisan will recognize that the above teachings may be modified in any of a number of ways yet still stay within the scope of the present invention.

As will be appreciated from the above, preferred seating systems that are optimized in accordance with the criteria outlined herein, and using the referenced materials, consistently should pass United States and European government test standards for motor vehicles (e.g., as addressed in FMVSS 207, FMVSS 210, FMVSS 225 (49 CFR 571.207, .210, .225) or ECE 17); all such standards being expressly incorporated by reference herein) as well as the requirements of automobile original equipment manufacturers and their suppliers.

The present invention contemplates techniques and methods for the optimization of one or more of substrate material selection, wall thickness, and section thickness, for realizing the desired stiffness and strength to meet traditionally demanding load requirements in automotive vehicles child seat anchor loads or cargo intrusion. The skilled artisan will recognize, however, that from application to application, design requirements will vary, and therefore a reasonable amount of experimentation may be needed to adapt the various teachings to the unique intended environment. By way of example, seat size, interface locations, and split ratio may affect final design. It is believed that the use of conventional computer aided engineering (CAE) techniques in combination with the present teachings will yield satisfactory results, which can be improved as desired with conventional techniques for localized steel reinforcement (e.g., in high stress areas, such as mounting areas).

What is claimed is:

1: A seating assembly for an automotive vehicle, comprising:
a. a molded plastic seat having at least a first wall portion including a forward wall portion and a rearward wall portion, a plurality of integrated reinforcement structures disposed on the forward wall portion, the rearward wall portion, or both, further including a cushion portion statically connected to a back portion and optionally a head restraint portion, the cushion portion including a top cushion wall portion and a bottom cushion wall portion, wherein the bottom cushion wall portion is adapted to connectively interface with the vehicle;
b. a foam support structure with a top foam surface, a side foam surface, and a bottom foam surface, wherein the bottom foam surface is disposed upon the forward wall portion of the molded plastic seat; and
c. a cover skin disposed on the top foam surface and the side foam surface;
wherein the seat assembly is capable of withstanding, without rupture, at least about 5000 Newtons in a direction in which the seat faces in a plane, parallel to the longitudinal centerline of the vehicle, and exhibits, upon rapid acceleration up to about 20 to about 30 g, no fragmentation of the seating assembly with at least a 15 kg mass placed behind the seating assembly and withstand a force producing a moment of 530 Nm in relation to the seating reference point (R) applied longitudinally and rearwards to the upper part of the back portion through a component simulating the back of a manikin, and the optional head restraint portion of the seat is capable of minimizing acceleration of spherical headform weighing at least 6.8 Kg to less than 80 g for more than continuous 3 ms striking at a speed of at least 24.1 Km/h, during an entire impact event.

2: The seating assembly of claim 1, wherein the cushion portion, the back portion, the head restraint portion and the plurality of integrated reinforcement structures comprise a single unitary molded plastic component.

3: The seating assembly of claim 1, includes a second wall portion including a second forward wall portion and a second rearward wall portion.

4: The seating assembly of claim 1, wherein the molded plastic seat is molded from a thermoplastic resin.

5: The seating assembly of claim 1, wherein the thermoplastic resin includes a fiber filled polyolefin.

6: The seating assembly of claim 1, wherein the molded plastic seat is fabricated in a single injection molding operation.

7: The seating assembly of claim 1, wherein the foam support structure is fabricated and joined with the molded plastic seat and the cover skin in a single foaming operation.

8: The seating assembly of claim 1, wherein the molded plastic includes an attachment feature for the optional head restraint portion.

9: A method of manufacturing a seating assembly for an automotive vehicle comprising the steps of:
a. forming a thermoplastic seat with a cushion portion integrally connected to a back portion and optionally a head restraint portion;
b. providing a cover skin;
c. placing the thermoplastic seat securely onto a lid portion of a foam mold;
d. placing the cover skin securely into a bowl portion of the foam mold;
e. introducing an expandable foam into the foam mold; and
f. expanding the expandable foam to fill the mold, thus joining the cover skin and the thermoplastic seat to the expanded foam creating the seating assembly.

10: The method of claim 9, wherein the cover skin is secured to the bowl by a step of applying a vacuum between the bowl and the cover skin.

11: The method of claim 9, wherein a step of closing the lid portion onto the bowl portion occurs after the expandable foam is introduced to the foam mold.
